(19) United States
(12) Patent Application Publication
(10) Pub. No.: US 2005/0255289 A1
(43) Pub. Date: Nov. 17, 2005

(54) Method for manufacture of cellular materials and structures for blast and impact mitigation and resulting structure

(76) Inventor: Haydn N.G. Wadley, Keswick, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 10/522,068

(22) PCT Filed: Jul. 23, 2003
(86) PCT No.: PCT/US03/23043

§ 371 Date: Jan. 21, 2005

Related U.S. Application Data
(60) Provisional application No. 60/398,373, filed on Jul. 25, 2002.

(51) Int. Cl. B32B 3/20

(52) U.S. Cl. 428/116

(57) ABSTRACT

Provided is the utilization of face panels (20) containing core materials (16) topologically structured at small scale, relative to a system (e.g. ship hull) that utilize them. They are optimized Lo absorb or reflect the energy subject to their while also possessing the ability to efficiently support high structural loads. It is entirely compatible with double-hull ship design concepts, because the volume between the hulls is used to locate the energy absorbing material substructures. The approach can be generalized to provide protection from impacts of low, intermediate or high intensity. The technology to design such structures requires materials selection and cell topology designs coupled with and techniques for the affordable manufacturing of structures that must he able to sustain severe dynamic deformations. It requires a coupling of effects occurring and phenomena that occur at the materials and structural levels.

### RELATED APPLICATIONS

This application claims priority from U.S. Provisional Application Ser. No. 60/398,373 filed on Jul. 25, 2002, entitled “Cellular Materials and Structures for Blast and Impact Mitigation in Structures and related Method and System,” the entire disclosure of which is hereby incorporated by reference herein.

### US GOVERNMENT RIGHTS

This invention was made with United States Government support under Grant No. N00014-01-1-1051, awarded by the Defense Advanced Research Projects Agency/Office of Naval Research. The United States Government has certain rights in the invention.

### FIELD OF THE INVENTION

The present invention relates to a structure fabricated using one or more arrays of cellular housings containing a cellular core therein that can be used as blast and impact mitigation structures.

### BACKGROUND OF THE INVENTION

The design of structures has yet to exploit emerging capabilities of cellular materials for blast and impact energy absorption. Such dynamic loading phenomena occur during automobile collisions, the grounding of ships and explosions in air or water. Dramatic improvements can be made in the design of structures to either absorb or reflect the mechanical energy by exploiting recent progress in cellular materials, sandwich panel fabrication and optimization.

There exists a need in the art for cellular designs that can be used as blast and impact mitigation structures. Additionally, there exists a need in the art for a cellular design whereby both face sheets and all the core constituents are maximally utilized to absorb (by plastic deformation) the dynamic mechanical energy.

### SUMMARY OF THE INVENTION

In one aspect, the present invention structure comprises: at least a first array of a plurality of cellular housings; and at least one cellular core disposed in at least a substantial number of the cellular housings. Moreover, the structure may further comprise at least one face panel disposed on or in communication with at least one array. The structure may include multiple arrays that are stacked upon one another or in communication with one another.

In another aspect, the present invention provides a method of constructing a structure comprising the steps of: providing a plurality of cellular housings; disposing at least one cellular core in at least a substantial number of the cellular housings; and bonding the cellular housings together to form at least a first array. Moreover, the method may further comprise bonding at least a first panel to or in communication with at least one array. The method may include bonding multiple arrays together or in communication with one another.

The invention itself, together with further objects and attendant advantages, will best be understood by reference to the following detailed description taken in conjunction with the accompanying drawings.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIGS. 1(A)-1(D) show schematic representations of an embodiment of the present invention. In one possible example, there may be achieved the concept for impact on blast energy absorption utilization periodic cellular metal structures made from corrosion resistant alloys, polymers, ceramic or composites. In another possible example, these water buoyant materials are used for the double hull of ship. In both cases a hierarchical cellular core structure is contained within a pair of facesheets (hulls). At the highest level, a square honeycomb structure (i.e., array of cellular housings) is shown. Within each cellular housing, another cellular structure (i.e., cellular core) is created. In FIG. 1(A) the structure (i.e., cellular core) is a hollow pyramid.

FIGS. 2(A)-2(D) show schematic representations of an embodiment of the present invention. In an alternative core topology, a triangular honeycomb contains truss core concepts that can be used to create structurally efficient high-energy absorption structures. In this case, a tripod truss core is contained inside the triangular honeycomb (i.e., array of triangular or pyramidal cellular housings).

FIGS. 3(A)-3(C) show a schematic representation of an alternative embodiment of the present invention. In one possible example, there may be hierarchical energy absorbing structures utilizing hollow powder filled cylinders. In one possible example, the hollow powder is weakly bonded and interacts with the tubes to increase the buckling spatial frequency. Additional energy is absorbed by powder friction and plastic compression of the powder. Other cellular materials can be used instead of the hollow spheres.

FIGS. 4(A)-(F) schematically show exploded views of alternative embodiments of the present inventions hierarchical cellular structures comprised of cellular housings and cellular cores. There is shown examples of exemplary of hierarchical dynamic energy mitigating core concepts. All permutations of large and small scale cellular topologies are provided or contemplated by the present invention.

FIG. 5 schematically shows a partially exploded view of an alternative embodiment of the present invention hierarchical cellular structures comprised of a cellular housing and cellular core. In an alternative core topology, a hexagonal cellular housing contains core concepts that can be used to create structurally efficient high-energy absorption structures.

### DETAILED DESCRIPTION OF THE INVENTION

The present invention approach utilizes sandwich panels containing core materials topologically structured at small scale, relative to a system (e.g. ship hull) that utilize them. They are optimized to absorb or reflect the energy subject while also possessing the ability to efficiently support high structural loads. It is entirely compatible with double-hull ship design concepts, because the volume between the hulls is used to locate the energy absorbing material substructures. The present invention approach can be generalized to provide protection from impacts of low, intermediate or high intensity.

The technology to design such structures requires materials selection and cell topology designs coupled with techniques for the affordable manufacturing of structures able to sustain severe dynamic deformations. It requires a coupling of effects and phenomena that occur at the materials and structural levels. The implementation of the protection approach requires advances in the fabrication of topologically optimized sandwich panels which is also disclosed herein this document.

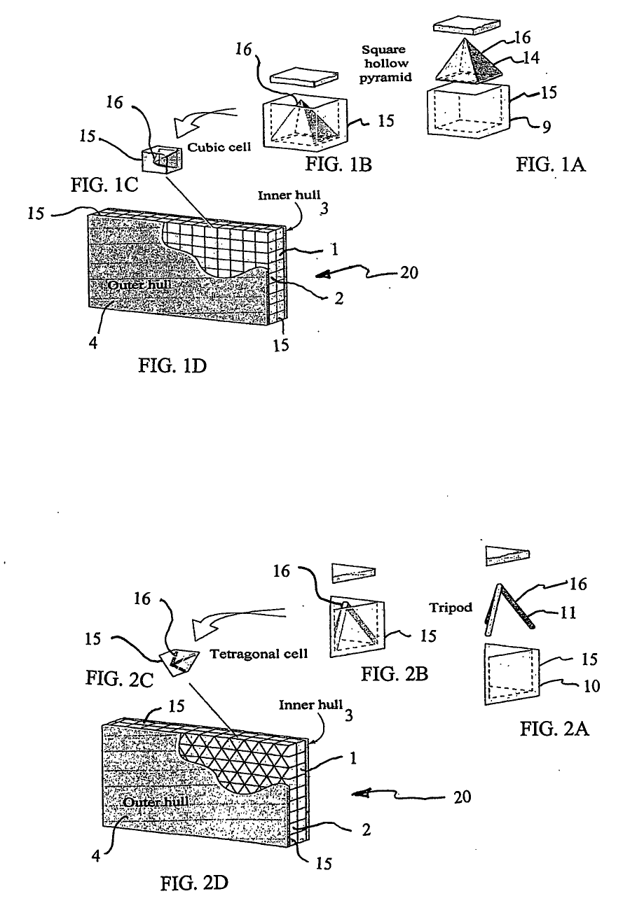

Turning now to the drawings, the subject invention, as shown In FIGS. 1, 2, 3, and 4, the structure 20 includes a first array 1 of cellular housings 15, as well as second array 2 (or more, but not shown) of cellular housings 15 in some instances. Located inside the cellular housings 15 are cellular cores 16. Additionally, bonded to the first array 1 and second array 2 are first panels 3 and second panels 4 (or more, but not shown). By stacking, a multilayered structure is envisaged with one, two or more layers and hierarchical cellular structure (i.e., first array 1 and/or second array 2 of cellular housings 15 of which contains cellular cores 16 therein. The arrays may be attached to one another as well as to the panels using various bonding techniques, such as brazing or other transient liquid phases, adhesives, diffusion bonding, resistance welding, electron welding, laser welding, or other desirable techniques.

Turning, to FIGS. 1(A)-1(D), there are shown schematic representations of an embodiment of the present invention. FIG. 1(A) is an exploded view of the present invention wherein the cellular housing 15 is rectangular (or square) shaped 9 and has a square (or rectangular) hollow pyramid 14cellular core therein. FIG. 1(B) is a partially assembled view of the present invention cellular housing 15. FIG. 1(C) is a view of the present invention assembled cellular housing 15 showing the cellular core 16 therein. FIG. 1(D) is a view of the present invention assembled structure 20 wherein the arrays 1, 2 of cellular housings 15 are sandwiched between the first panel 3 and second panel 4.

Turning, to FIGS. 2(A)-2(D), there are shown schematic representations of an embodiment of the present invention. FIG. 2(A) is an exploded view of the present invention wherein the cellular housing 15 is a triangular honeycomb shape 10 and has a tripod truss 11 cellular core therein. FIG. 2(B) is a partially assembled view of the present invention cellular housing 15. FIG. 2(C) is a view of the present invention assembled cellular housing 15 showing the cellular core 16 therein. FIG. 2(D) is a view of the present invention assembled structure 20 wherein the arrays 1, 2 of cellular housings 15 are sandwiched between the first panel 3 and second panel 4.

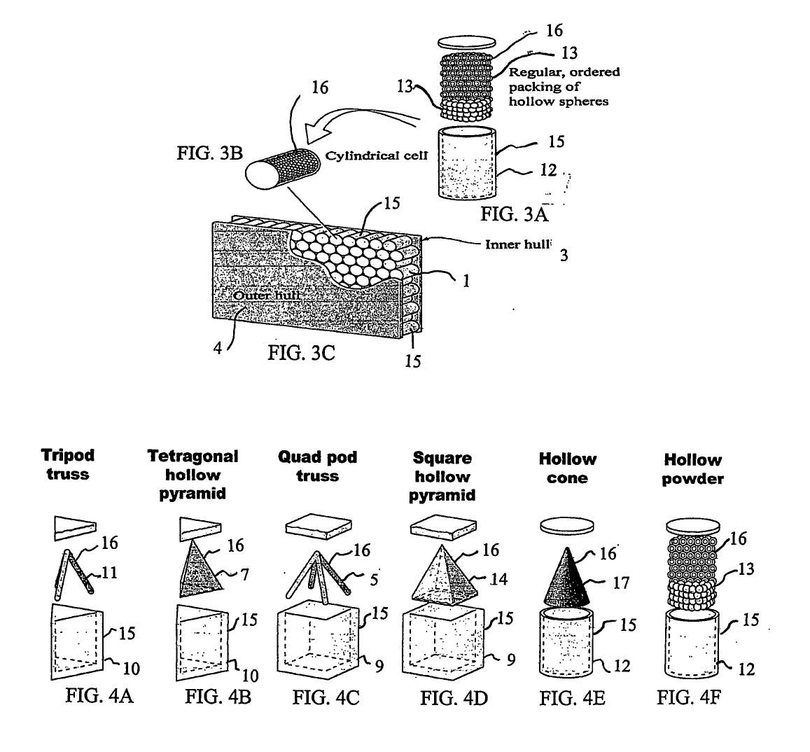

Turning, to FIGS. 3(A)-3(C), there are shown schematic representations of an embodiment of the present invention. FIG. 3(A) is an exploded view of the present invention wherein the cellular housing 15 is circular tubular shaped 12 and has a cluster of spheres 13 (hollow and/or solid) as the cellular core 16 therein. FIG. 3(B) is a view of the present invention assembled cellular housing 15 showing the cellular core 16 therein. FIG. 3(C) is a view of the present invention assembled structure 20 wherein the first arrays 1 of cellular housings 15 are sandwiched between the first panel 3 and second panel 4.

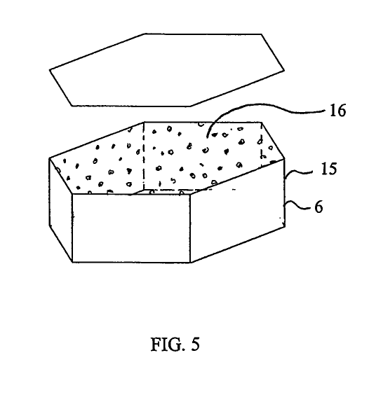

Similarly, FIGS. 4(A)-(F) schematically show exploded views of alternative embodiments of the present invention cellular housings 15. For instance, FIG. 4(A) shows a cellular housing 15 being a tetrahedral shape 10 with a cellular core 16 that is a tripod truss 11, which may be hollow or solid. FIG. 4(B) shows a cellular housing 15 being a tetrahedral shape 10 with a cellular core 16 that is pyramidal 7, which may be hollow or solid. FIG. 4(C) shows a cellular housing 15 being a rectangular (or cubic) shaped 9 (which could also be hexagonal) with a cellular core 16 that is a quad pod truss 5, which may be hollow or solid, and which could also have five or more legs. FIG. 4(D) shows a cellular housing 15 being a rectangular (or cubic) shaped 9 with a cellular core 16 that is a square pyramidal 14, which may be hollow or solid and which may be hexagonal. FIG. 4(E) shows a cellular housing 15 being a tubular shaped 12 with a cellular core 16 that is a cone 17, which may be hollow or solid. FIG. 4(F) shows a cellular housing 15 being a tubular shaped 12 with a cellular core 16 that is a cluster of spheres 13, which may be hollow and/or solid.

Moreover, it should be appreciated that not all cellular housings necessarily contain a cellular core therein. And similarly, some cellular housings may contain more than one cellular core therein or more a variable types of cellular cores in a single cellular housing or singular array of housings.

Additionally, it should also be appreciated that the hierarchy can be reversed such that the cellular housings are inside the cellular cores, such as the cubes are inside the pyramids (rather than the pyramids inside the cubes).

Further yet, it should be appreciated that the cellular housings and cellular cores may comprise of polyhedrons and polygons of any variety of desired shapes and number of legs, sides or faces.

Still further, it should be appreciated that the cellular housings may contain cellular cores that comprise of open and/or closed cell foams or other porous materials including granular powders. Such examples of open and closed cell foams are discussed in co-pending and co-assigned PCT International Application No. PCT/US01/22266, entitled “Heat Exchange Foam,” filed on Jul. 16, 2001, and corresponding U.S. application Ser. No. 10/333,004, filed Jan. 14, 2003, of which are hereby incorporated by reference herein in their entirety. Turning to FIG. 5, FIG. 5 schematically shows a partially exploded view of an alternative embodiment of the present invention hierarchical cellular structures comprised of a cellular housing 15 and cellular core 16. In an alternative core topology or makeup, the cellular housing 15 contains core concepts that can be used to create structurally efficient high-energy absorption structures. In this case, the cellular housing 15 is hexagonal shaped 6 comprising any one of the following type cellular cores 16: a) random aggregate of hollow or solid powder particles (with or without interparticle bonding); b) stochastic foam; c) porous or solid materials; d) periodic cellular structures; e) solid powder aggregates; f) lightweight, highly compliant materials such as elastomers; g) low density polymers, metal, ceramic or polymer foams; or h) polymer cast into the cellular housing (or cellular core itself), as well as any combination thereof.

The topological choices for the core material of a sandwich panel structure 20, energy absorbing system will comprise periodic designs of cellular cores 16, based on corrosion resistant metals such as stainless steels, titanium, other metals/alloys and other materials (including polymers, ceramics and composites). These materials are also formed into the hollow spheres, truncated cones, corrugations and trusses making upper the lower hierarchy structure. These can be placed within large boxes, i.e. cellular housing 15, of polygonal cross section or arrays of circular or elliptical cross section tubes and bonded to face sheets, i.e. first and second panels 3,4. Stochastic foam core systems can also be used but frequently have inferior capabilities. The present invention systems 20 can out perform the existing concepts which are cellular materials within an ensemble of hollow bonded tubes or a hexagonal honeycomb. A simple means of fabrication for a metal system consists of making the cellular cores 16 which are spray coated with transient liquid phase precursors, face sheets 3,4 are superposed and the lay-up heated to create bonding. This approach can be used to create wide panels (e.g., many meters) with cores having a range of thickness. Corrosion resistant steels for naval applications are feasible. Aluminum alloy and titanium structures can be made this way also. In the case of some metal systems, subsequent quenching and tempering can be used to manipulate the strength and strain hardening characteristics. Super plastic forming/diffusion can be used to create analogous structures from some titanium alloys.

Hollow, space filling three-dimensional arrays of square and triangular boxes, i.e., cellular housings 15, can be constructed from sheet and bonded by transient liquid phases. Similar bonding can be used to create sheets of hollow tube arrays forming the cellular housings 15 and having spheres therein for the cellular cores 16. These can be placed between face sheets 3,4 and used to create structures with large energy absorption to maximize the number of plastic buckles per unit length. Variables include the cross sectional shape, the aspect ratio and wall thickness of the box/tubes and the topology of the cellular materials within.

Recent assessments have highlighted the potential for conical configurations to achieve large energy absorption. As these cores compress, a plastic knuckle initiates at the apex and propagates toward the base. This process allows all material elements in the core to experience large-scale plastic strains. These cellular housings 15 and cellular cores 16 have low relative density, in the approximate 1-5% range. Panels can be made by using rolling and CNC bending techniques to create structures 20 and exploiting transient liquid phase (TLP) bonding to attach the faces. This approach has the attributes of low cost, uniform cells, many materials choices, mechanical properties representative of wrought metals, and a capability to manufacture in large size.

Truss core topologies are highly applicable. The structural performance of cellular housings 15 consisting of cellular cores 16 of tetrahedral, pyramidal and Kagome trusses will result in minimum weight designs superior to hexagonal honeycombs. Cellular housings 15 and cellular cores 16 may be fabricated using metal stamping and CNC bending or progressive rolling processes to create three or four sided core structures with apices oriented perpendicular to the plane. The cellular housings 15 and cellular cores 16 of this type can be built into panels using the TLP and diffusion bonding methods noted above, then attached to rigid supports and tested to determine the overall load/deflection response prior to face tearing. Other materials can be bonded with adhesives or low melting point glasses.

The large interior spaces within constructed hollow boxes and tubes thereby forming the cellular housings provide novel opportunities for additional energy absorption. It is also possible to inexpensively place three and four legged trusses or their closed cell analogs (tetrahedral and pyramids), i.e., cellular cores 16, in boxes and triangular tube arrays and add hollow powder. These ideas are illustrative of hierarchical concepts that dynamic impact/blast loading and efficiency of static load support. The interior structures can be optimized to control the modes of collapse of the larger scale cellular structure diving into modes that maximize energy absorption. For example, plastic compression is preferred to bending because a higher volume of material undergoes energy absorbing plastic strain.

In general the energy absorption of a smaller length scale porous structure subject to severe impact loading is governed by the extent of its plastic deformation. When high strain shape change of the internal topology by plasticity (as opposed to bending), as the volume of plastically deformed material and its strain are increased, the energy absorbed increases. Further increases occur by heating (increased by the selection of the system heat capacity) and frictional dissipation. In conjunction with the fabrication approaches described below, these principles enable creation of novel topological concepts that maximize the absorption of mechanical impulses from impacts and blasts. These include hierarchical concepts involving structures with numerous length scales and sequential energy absorption activation pressures. Examples include cellular housings 15 that are tube arrays containing hollow metal powder, or cubic box arrays containing cones or pyramids, i.e., cellular cores 16, inside of which is placed granular materials for frictional dissipation and plastic compaction. For example, a weakly bonded ceramic or metal powder.

The present invention provides a basis for designing and manufacturing core topologies and panel designs in accordance with two different scenarios: one for high intensity and the other for moderate impacts and blasts. The former establish rules for the design of cores and faces with strength sufficient to reflect the incident impulse or its absorption by plasticity. The latter create designs that allow the maximum energy absorption per unit mass by various dissipation mechanisms associated with deformation of cones.

It should be appreciated that the first and second panels 3, 4 (or any added in addition thereto) as discussed throughout can be planar, substantially planar, and/or curved shape, with various contours as desired and required. As such the respective arrays of cellular housings may be shaped and bent accordingly.

There are numerous other functionalities, which can be added into or with these structures 20 (or with these arrays of cellular housings) making them ideal candidates for “structure plus” multifunctional materials. For example the present invention general structural material may be involved in architecture (for example: pillars, walls, shielding, foundations or floors for tall buildings or pillars, wall shielding floors, for regular buildings and houses), the civil engineering field (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways) and the machine structure field (frame structures for carrying system, carrying pallets, frame structure for robots, etc.), the automobile (the body, frame, doors, chassis, roof and floor, side beams, bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), the space station (the main body, floor, wall, etc.), the submarine (the body, frame, etc.), and is related to the structural material which requires extreme dynamic strength.

Flexible, low cost approaches for the bonding of metallic sub assemblies (trusses, hollow sphere, tubes, with face sheets) of different materials including metallic alloys can be fabricated. For metals, the techniques include the use of transient liquid phases and diffusion bonding. Other methods such as electric discharge welding of contacts and adhesive bonding can also be used. Adhesives can be used for other materials.

Many methods for scalable fabrication of periodic core structures with precisely controlled topologies exist or can be devised. Methods for metals include sheet perforation, CNC bending, roll forming, hot isothermal forging, super plastic deformation, powder injection molding and various casting concepts. Each method has advantages and disadvantages for the alloy systems of interest (e.g. stainless steels, aluminum, copper, nickel and titanium alloys). These cellular housings 15 can be placed within a cellular array with cubic, triangular or other polygonal cross section as well as arrays of tubes.

Finally, we turn to the methods for producing the above embodiments of the subject invention. A possible method for producing structure 20 as shown in FIGS. 1, 2, 3, and 4 is as described, for example, in the above detailed description. The first and subsequent arrays of cellular housings 1, 2 are aligned and bonded at desirable orientations and locations. Bonding techniques may include, but are not limited to, the techniques listed above in the detailed description of the first embodiment of the subject invention. The stacking/aligning and bonding steps can be repeated to add and bond further arrays of cellular housings until desired size or shape is obtained. As a final step, structural panels can be added to sandwich the stacked arrays on exterior surfaces (or intermediate or interior layers if desired) to form a structural panel or, for example, a ship hull.

The steps of manufacture may be performed in various orders and/or with modified procedures or structures suitable to a given application.

Overall, the subject invention provides blast and impact mitigation structures with superior structural integrity and a method of fabrication that can be simple and inexpensive to perform.

The following publications, patents, patent applications are hereby incorporated by reference herein in their entirety:
a. “Cellular Metals Manufacturing: An Overview of Stochastic and Periodic Concepts”, H. N. G. Wadley, Met Foam 2001 Conference Proceedings, pp. 137-146, 2001.
b. “Cellular Metal Truss Core Sandwich Structures”, D. J. Sypeck and H. N. G. Wadley, Met Foam 2001 Conference Proceedings, pp. 381-386, 2001.
c. “The Structural Performance of Near-Optimized Truss Core Panels”, S. Chiras, D. R. Mumm, A. G. Evans, N. Wicks, J. W. Hutchinson, S. Fichter, K. Dharmasena, and H. N. G. Wadley, International Journal of Solids and Structures, In Press, January 2002.
d. “On the Performance of Light Weight Metallic Panels Fabricated Using Textile Technology”, D. R. Mumm, S. Chiras, A. G. Evans, J. W. Hutchinson, D. J. Sypeck, and H. N. G. Wadley, International Journal of Mechanical Sciences, submitted August 2001.
e. “Cellular Metals Manufacturing”, H. N. G. Wadley, Metfoam Issue of Advanced Engineering Materials, submitted March 2002.
f. PCT International Application No. PCT/US01/17363, entitled “Multifunctional Periodic Cellular Solids And The Method Of Making Thereof,” filed on May 29, 2001, and corresponding U.S. application Ser. No. 10/296,728, filed Nov. 25, 2002.
g. PCT International Application No. PCT/US02/17942, entitled “Multifunctional Periodic Cellular Solids And The Method Of Making Thereof,” filed on Jun. 6, 2002.
h. PCT International Application No. PCT/US03/PCT/US03/16844, entitled “Method for Manufacture of Periodic Cellular Structure and Resulting Periodic Cellular Structure,” filed on May 29, 2003.
i. U.S. Pat. No. 6,017,597 to Minakami et al.
j. PCT/US96/12626 to Jurisich et al.
k. PCT/IB99/00964 to Hall et al.
l. PCT/GB90/01723 to Lee et al.
m. EP 1 238 741 A1 to Leholm et al.

Of course it should be understood that a wide range of changes and modifications could be made to the preferred and alternate embodiments described above. It is therefore intended that the foregoing detailed description be understood that it is the following claims, including all equivalents, which are intended to define the scope of this invention.

1. A structure comprising:
at least a first array of a plurality of cellular housings; and
at least one cellular core disposed in at least a substantial number of said cellular housings.

2. The structure of claim 1, further comprising:
at least a second array of a plurality of cellular housings; and
at least one cellular core disposed in at least a substantial number of said at least second arrays of cellular housings.

3. The structure of claim 1 or 2, further comprising:
a first panel disposed on one of said arrays of cellular housings.

4. The structure of claim 3, further comprising:
a second panel disposed on one of said arrays of cellular housings distal from said first panel.

5. The structure of claim 4, wherein at least a plurality of said cellular housings have a rectangular shape.

6. The structure of claim 5, wherein at least a plurality of said cellular cores have a shape of at least one of tripod truss, quad pod truss, tetrahedral, cube, hexagon, pyramidal, kagome, cube, hexagon, cluster of solid or hollow spheres, or combinations thereof or other non-limiting arrangements.

7. The structure of claim 5, wherein at least a plurality of said cellular cores comprise open and/or closed cell foams or other porous materials.

8. The structure of claim 5, wherein at least a plurality of said cellular cores comprise granular powders or other porous materials.

9. The structure of claim 5, wherein at least a plurality of said cellular cores comprise at least one of a) random aggregate of hollow or solid powder particles (with or without interparticle bonding); b) stochastic foam; c) porous or solid materials; d) periodic cellular structures; e) solid powder aggregates; f) lightweight, highly compliant materials such as elastomers; g) low density polymers, metal, ceramic or polymer foams; or h) polymer cast into the cellular housing (or cellular core itself), or combinations thereof of or other non-limiting arrangements.

10. The structure of claim 4, wherein at least a plurality of said cellular housings have triangular shape.

11. The structure of claim 10, wherein at least a plurality of said cellular cores have a shape of at least one of pyramidal, quad pod, tripod, cluster of solid or hollow spheres, cube, hexagon, tetrahedral, pyramidal, or kagome, or combinations thereof or other non-limiting arrangements.

12. The structure of claim 10, wherein at least a plurality of said cellular cores comprise open and/or closed cell foams or other porous materials.

13. The structure of claim 10, wherein at least a plurality of said cellular cores comprise granular powders or other porous materials.

14. The structure of claim 10, wherein at least a plurality of said cellular cores comprise at least one of a) random aggregate of hollow or solid powder particles (with or without interparticle bonding); b) stochastic foam; c) porous or solid materials; d) periodic cellular structures; e) solid powder aggregates; f) lightweight, highly compliant materials such as elastomers; g) low density polymers, metal, ceramic or polymer foams; or h) polymer cast into the cellular housing (or cellular core itself), or combinations thereof of or other non-limiting arrangements.

15. The structure of claim 4, wherein at least a plurality of said cellular housings have a tubular shape.

16. The structure of claim 15, wherein at least a plurality of said cellular cores comprise cluster of solid or hollow spheres, pyramidal, quad pod, tripod, cube, hexagon, tetrahedral, pyramidal, or kagome, or combination thereof or other non-limiting arrangements.

17. The structure of claim 15, wherein at least a plurality of said cellular cores comprise open and/or closed cell foams or other porous materials.

18. The structure of claim 15, wherein at least a plurality of said cellular cores comprise granular powders or other porous materials.

19. The structure of claim 15, wherein at least a plurality of said cellular cores comprise at least one of a) random aggregate of hollow or solid powder particles (with or without interparticle bonding); b) stochastic foam; c) porous or solid materials; d) periodic cellular structures; e) solid powder aggregates; f) lightweight, highly compliant materials such as elastomers; g) low density polymers, metal, ceramic or polymer foams; or h) polymer cast into the cellular housing (or cellular core itself), or combinations thereof of or other non-limiting arrangements.

20. The structure of claim 4, wherein at least a plurality of said cellular housings have a hexagonal shape.

21. The structure of claim 20, wherein at least a plurality of said cellular cores have a shape of at least one of tripod truss, quad pod truss, tetrahedral, cube, hexagon, pyramidal, kagome, cube, hexagon, cluster of solid or hollow spheres, or combinations thereof or other non-limiting arrangements.

22. The structure of claim 20, wherein at least a plurality of said cellular cores comprise open and/or closed cell foams or other porous materials.

23. The structure of claim 20, wherein at least a plurality of said cellular cores comprise granular powders or other porous materials.

24. The structure of claim 20, wherein at least a plurality of said cellular cores comprise at least one of a) random aggregate of hollow or solid powder particles (with or without interparticle bonding); b) stochastic foam; c) porous or solid materials; d) periodic cellular structures; e) solid powder aggregates; f) lightweight, highly compliant materials such as elastomers; g) low density polymers, metal, ceramic or polymer foams; or h) polymer cast into the cellular housing (or cellular core itself), or combinations thereof of or other non-limiting arrangements.

25. The structure of claim 4, wherein said second panel is bonded to at least one of said arrays, wherein said bond is at least one of brazing bonded, other transient liquid phase bonded, UV welding bonded, adhesives, resistance welding, laser welding bonded, or diffusion welding bonded.

26. The structure of claim 4, wherein said structure partially comprises a double ship hull.

27. The structure of claim 4, wherein said structure comprises a double ship hull.

28. The structure of claim 4, wherein said structure comprises at least one of: architecture (for example: pillars, walls, shielding, foundations or floors for tall buildings or pillars, wall shielding floors, for regular buildings and houses), civil engineering field (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways) and machine structure field (frame structures for carrying system, carrying pallets, frame structure for robots, etc.), the automobile (the body, frame, doors, chassis, roof and floor, side beams, bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), space station (the main body, floor, wall, etc.), and submarine (the body, frame, etc.).

29. The structure of claim 3, wherein said first panel is bonded to at least one of said arrays, wherein said bond is at least one of brazing bonded, other transient liquid phase bonded, UV welding bonded, adhesives, resistance welding, laser welding bonded, or diffusion welding bonded.

30. The structure of claim 3, wherein said structure partially comprises a ship hull.

31. The structure of claim 3, wherein said structure comprises a ship hull.

32. The structure of claim 3, wherein said structure comprises at least one of: architecture (for example: pillars, walls, shielding, foundations or floors for tall buildings or pillars, wall shielding floors, for regular buildings and houses), civil engineering field (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways) and machine structure field (frame structures for carrying system, carrying pallets, frame structure for robots, etc.), the automobile (the body, frame, doors, chassis, roof and floor“side beams, bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), space station (the main body, floor, wall, etc.), and submarine (the body, frame, etc.).

33. The structure of claim 2, wherein a plurality of said arrays are bonded to one another, wherein said bond is at least one of brazing bonded, other transient liquid phase bonded, UV welding bonded, adhesives, resistance welding, laser welding bonded, or diffusion welding bonded.

34. The structure of claim 1 or 2, wherein at least some of said cellular housings and at least some of said cellular cores are made from a material selected from the group consisting of polymers, metals, alloys, ceramics, stainless steels, aluminum alloys, and titanium alloys.

35. The structure of claim 1 or 2, wherein at least some of said cellular housings and at least some of said cellular cores are made from composites formed of one or more of a material selected from the group consisting of polymers, metals, alloys, ceramics, stainless steels, aluminum alloys and titanium alloys.

36. A method of constructing a structure comprising:
providing a plurality of cellular housings;
disposing at least one cellular core in at least a substantial number of said cellular housings; and
bonding said cellular housings together to form at least a first array.

37. The method of claim 36, further comprising:
bonding said cellular housings together to form at least a second array.

38. The method of claim 36, further comprising:
bonding at least a first panel to said first array.

39. The method of claim 36, further comprising:
bonding at least a second panel to at least one of select said arrays.
